(19) United States
(12) Patent Application Publication
(10) Pub. No.: US 2023/0054832 A1
(43) Pub. Date: Feb. 23, 2023

(54) MULTI-SLOT APERIODIC SOUNDING REFERENCE SIGNAL

(71) Applicant: QUALCOMM Incorporated, San Diego, CA (US)

(72) Inventors: Runxin WANG, San Diego, CA (US); Muhammad Sayed Khairy ABDELGHAFFAR, San Jose, CA (US); Yu ZHANG, San Diego, CA (US); Alexandros MANOLAKOS, Escondido, CA (US); Weimin DUAN, San Diego, CA (US)

(21) Appl. No.: 17/759,691

(22) PCT Filed: Sep. 4, 2020
(86) PCT No.: PCT/CN2020/113510

§ 371 Date: Jul. 28, 2022

(30) Foreign Application Priority Data
Feb. 14, 2020 (WO) PCTCN2020075169

(51) Int. Cl. H04L 5/00; H04W 72/04; H04W 72/12

(52) U.S. Cl. CPC H04L 5/0048; H04W 72/0446; H04W 72/1242; H04L 5/0053

(57) ABSTRACT

Various aspects of the present disclosure generally relate to wireless communication. In some aspects, a user equipment may receive, from abase station, a sounding reference signal (SRS) configuration indicating a number of candidate slots for transmission of a multi-slot aperiodic SRS (A-SRS); receive, from the base station, an SRS trigger, the SRS trigger comprising an indication of an A-SRS resource set, the A-SRS resource set comprising a plurality of A-SRS resources corresponding to the number of candidate slots; and transmit, in response to the SRS trigger, the multi-slot A-SRS in one or more of a plurality of candidate slots using at least a portion of the A-SRS resource set. Numerous other aspects are provided.

### CROSS-REFERENCE TO RELATED APPLICATION

This application claims priority to PCT/CN2020/075169, filed on Feb. 14, 2020, entitled “MULTI-SLOT APERIODIC SOUNDING REFERENCE SIGNAL,” which is hereby expressly incorporated by reference herein.

### FIELD OF THE DISCLOSURE

Aspects of the present disclosure generally relate to wireless communication and to techniques and apparatuses for transmitting a multi-slot aperiodic sounding reference signal.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In some aspects, a method of wireless communication performed by a user equipment (UE) includes receiving, from a base station (BS), a sounding reference signal (SRS) configuration indicating a number of candidate slots for transmission of a multi-slot aperiodic SRS (A-SRS); receiving, from the BS, an SRS trigger, the SRS trigger comprising an indication of an A-SRS resource set, the A-SRS resource set comprising a plurality of A-SRS resources corresponding to the number of candidate slots; and transmitting, in response to the SRS trigger, the multi-slot A-SRS in one or more of a plurality of candidate slots using at least a portion of the A-SRS resource set.

In some aspects, a method of wireless communication performed by a base station includes transmitting, to a UE, an SRS configuration indicating a number of candidate slots for transmission of a multi-slot A-SRS; transmitting, to the UE, an SRS trigger, the SRS trigger comprising an indication of an A-SRS resource set, the A-SRS resource set comprising a plurality of A-SRS resources corresponding to the number of candidate slots; and receiving, in response to the SRS trigger, the multi-slot A-SRS that is transmitted in one or more of a plurality of candidate slots using at least a portion of the A-SRS resource set.

In some aspects, a UE for wireless communication includes a memory; and one or more processors operatively coupled to the memory, the memory and the one or more processors configured to: receive, from a BS, an SRS configuration indicating a number of candidate slots for transmission of a multi-slot A-SRS; receive, from the BS, an SRS trigger, the SRS trigger comprising an indication of an A-SRS resource set, the A-SRS resource set comprising a plurality of A-SRS resources corresponding to the number of candidate slots; and transmit, in response to the SRS trigger, the multi-slot A-SRS in one or more of a plurality of candidate slots using at least a portion of the A-SRS resource set.

In some aspects, a base station for wireless communication includes a memory; and one or more processors operatively coupled to the memory, the memory and the one or more processors configured to: transmit, to a UE, an SRS configuration indicating a number of candidate slots for transmission of a multi-slot A-SRS; transmit, to the UE, an SRS trigger, the SRS trigger comprising an indication of an A-SRS resource set, the A-SRS resource set comprising a plurality of A-SRS resources corresponding to the number of candidate slots; and receive, in response to the SRS trigger, the multi-slot A-SRS that is transmitted in one or more of a plurality of candidate slots using at least a portion of the A-SRS resource set.

In some aspects, a non-transitory computer-readable medium storing one or more instructions for wireless communication includes one or more instructions that, when executed by one or more processors of a user equipment (UE), cause the one or more processors to: receive, from a BS, an SRS configuration indicating a number of candidate slots for transmission of a multi-slot A-SRS; receive, from the BS, an SRS trigger, the SRS trigger comprising an indication of an A-SRS resource set, the A-SRS resource set comprising a plurality of A-SRS resources corresponding to the number of candidate slots; and transmit, in response to the SRS trigger, the multi-slot A-SRS in one or more of a plurality of candidate slots using at least a portion of the A-SRS resource set.

In some aspects, a non-transitory computer-readable medium storing one or more instructions for wireless communication includes one or more instructions that, when executed by one or more processors of a base station, cause the one or more processors to: transmit, to a UE, an SRS configuration indicating a number of candidate slots for transmission of a multi-slot A-SRS; transmit, to the UE, an SRS trigger, the SRS trigger comprising an indication of an A-SRS resource set, the A-SRS resource set comprising a plurality of A-SRS resources corresponding to the number of candidate slots; and receive, in response to the SRS trigger, the multi-slot A-SRS that is transmitted in one or more of a plurality of candidate slots using at least a portion of the A-SRS resource set.

In some aspects, an apparatus for wireless communication includes means for receiving, from a BS, an SRS configuration indicating a number of candidate slots for transmission of a multi-slot A-SRS; means for receiving, from the BS, an SRS trigger, the SRS trigger comprising an indication of an A-SRS resource set, the A-SRS resource set comprising a plurality of A-SRS resources corresponding to the number of candidate slots; and means for transmitting, in response to the SRS trigger, the multi-slot A-SRS in one or more of a plurality of candidate slots using at least a portion of the A-SRS resource set.

In some aspects, an apparatus for wireless communication includes means for transmitting, to a UE, an SRS configuration indicating a number of candidate slots for transmission of a multi-slot A-SRS; means for transmitting, to the UE, an SRS trigger, the SRS trigger comprising an indication of an A-SRS resource set, the A-SRS resource set comprising a plurality of A-SRS resources corresponding to the number of candidate slots; and means for receiving, in response to the SRS trigger, the multi-slot A-SRS that is transmitted in one or more of a plurality of candidate slots using at least a portion of the A-SRS resource set.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of transmitting an aperiodic sounding reference signal (A-SRS), in accordance with various aspects of the present disclosure.

FIGS. 4 and 5 are diagrams illustrating examples of transmitting a multi-slot aperiodic sounding reference signal, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a base station, in accordance with various aspects of the present disclosure.

### DETAILED DESCRIPTION

Current NR specifications support transmitting an A-SRS in only one slot after triggering. Thus, a base station may trigger an A-SRS multiple times to evaluate uplink channels associated with different antennae, different UEs, different channels, different aggregated carriers, and/or the like. Additionally, under current specifications, slot offset is the only A-SRS parameter that can be dynamically configured.

In some aspects, techniques described herein may enable a base station to trigger an A-SRS for transmission on more than one slot (referred to herein as a “multi-slot A-SRS”). In some aspects, techniques described herein for triggering a multi-slot A-SRS using a single DCI transmission may facilitate enhanced usefulness of the SRS without increasing overhead. In some aspects, a base station may be able to dynamically configure the duration of the A-SRS transmission, the periodicity of the A-SRS transmission, and the selection of SRS resources from an SRS resource set to be transmitted. Some aspects of this increased functionality may facilitate more efficient evaluation and scheduling of uplink channels, thereby improving uplink reliability, quality of service, and/or the like.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

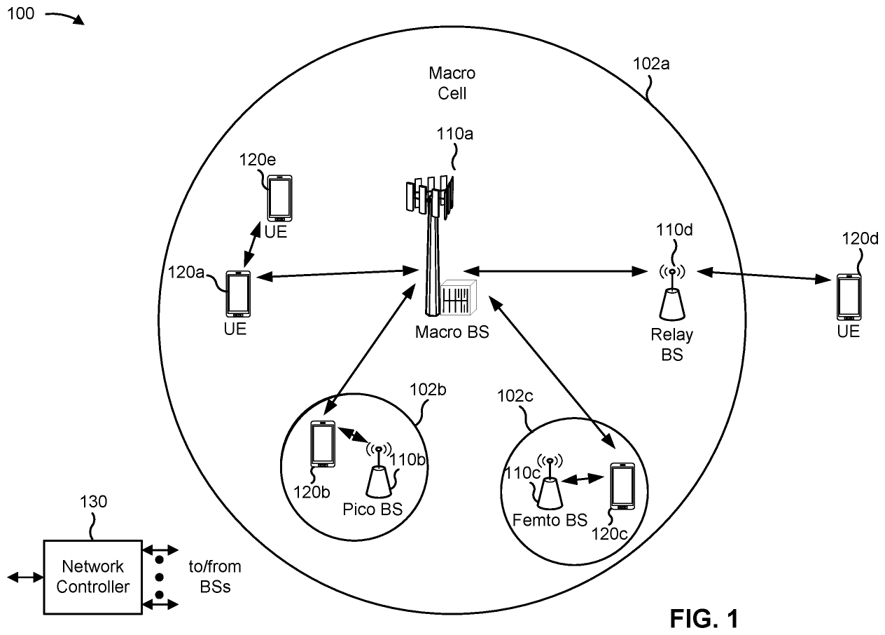

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used. In some aspects, a UE may be configured to transmit a multi-slot aperiodic sounding reference signal (A-SRS) to a BS to facilitate uplink signal evaluation by the BS.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, etc.

Wireless network 100 may be a heterogeneous network that includes BSs of different types, e.g., macro BSs, pico BSs, femto BSs, relay BSs, etc. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time—frequency resources and having a cellular configuration, a P2P configuration, and a mesh configuration, a scheduling entity and one or more subordinate entities may communicate utilizing the scheduled resources.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples may differ from what is described with regard to FIG. 1.

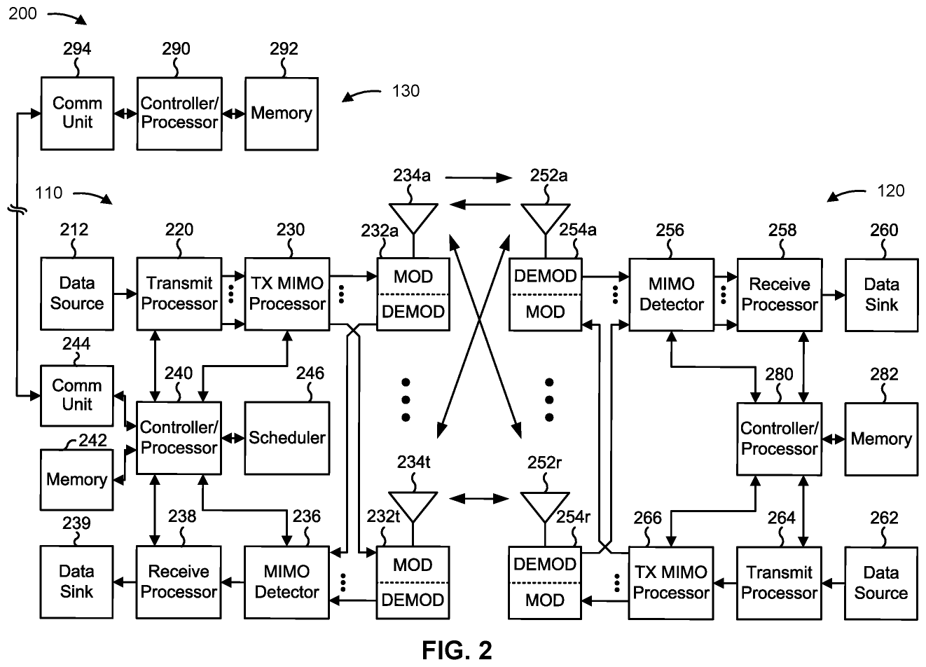

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), etc. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, etc.) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

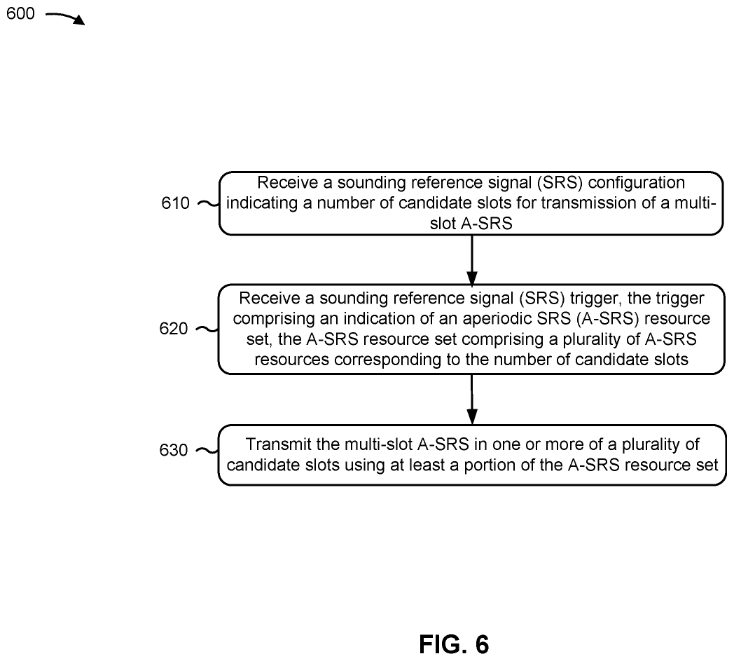

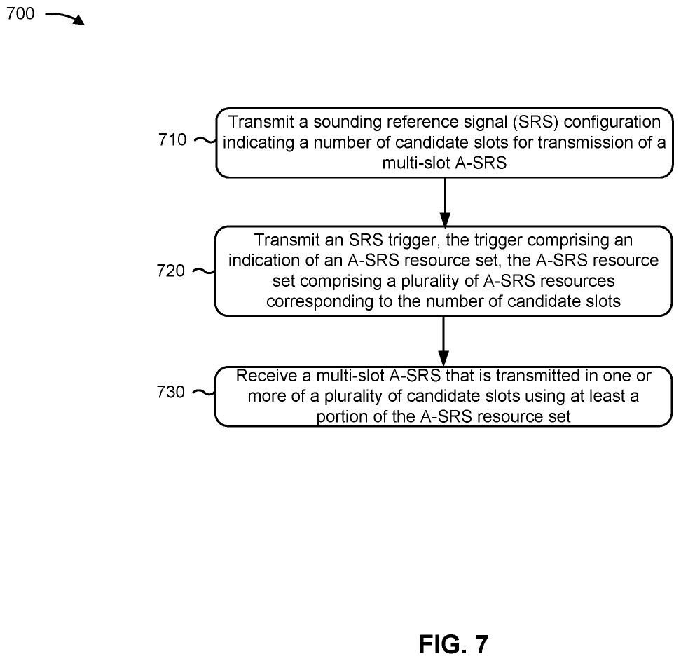

Controller/processor 240 of base station 110, controller/processor 280 of UE 120, and/or any other component(s) of FIG. 2 may perform one or more techniques associated with transmitting a multi-slot aperiodic sounding reference signal, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. A scheduler 246 may schedule UEs for data transmission on the downlink and/or uplink.

The stored program codes, when executed by processor 280 and/or other processors and modules at UE 120, may cause the UE 120 to perform operations described with respect to process 600 of FIG. 6, and/or other processes as described herein. The stored program codes, when executed by processor 240 and/or other processors and modules at base station 110, may cause the base station 110 to perform operations described with respect to process 700 of FIG. 7, and/or other processes as described herein. A scheduler 246 may schedule UEs for data transmission on the downlink and/or uplink.

In some aspects, UE 120 may include means for receiving, from a base station (BS), a sounding reference signal (SRS) configuration indicating a number of candidate slots for transmission of a multi-slot aperiodic SRS (A-SRS); means for receiving, from the BS, an SRS trigger, the SRS trigger comprising an indication of an aperiodic SRS (A-SRS) resource set, the A-SRS resource set comprising a plurality of A-SRS resources corresponding to the number of candidate slots; means for transmitting, in response to the SRS trigger, the multi-slot A-SRS in one or more of a plurality of candidate slots using at least a portion of the A-SRS resource set; and/or the like. In some aspects, such means may include one or more components of UE 120 described in connection with FIG. 2.

In some aspects, base station 110 may include means for transmitting, to a UE, an SRS configuration indicating a number of candidate slots for transmission of a multi-slot A-SRS; means for transmitting, to the UE, an SRS trigger, the SRS trigger comprising an indication of an A-SRS resource set, the A-SRS resource set comprising a plurality of A-SRS resources corresponding to the number of candidate slots; means for receiving, in response to the SRS trigger, the multi-slot A-SRS that is transmitted in one or more of a plurality of candidate slots using at least a portion of the A-SRS resource set; and/or the like. In some aspects, such means may include one or more components of base station 110 described in connection with FIG. 2.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of processor 280.

As indicated above, FIG. 2 is provided merely as an example. Other examples may differ from what is described with regard to FIG. 2.

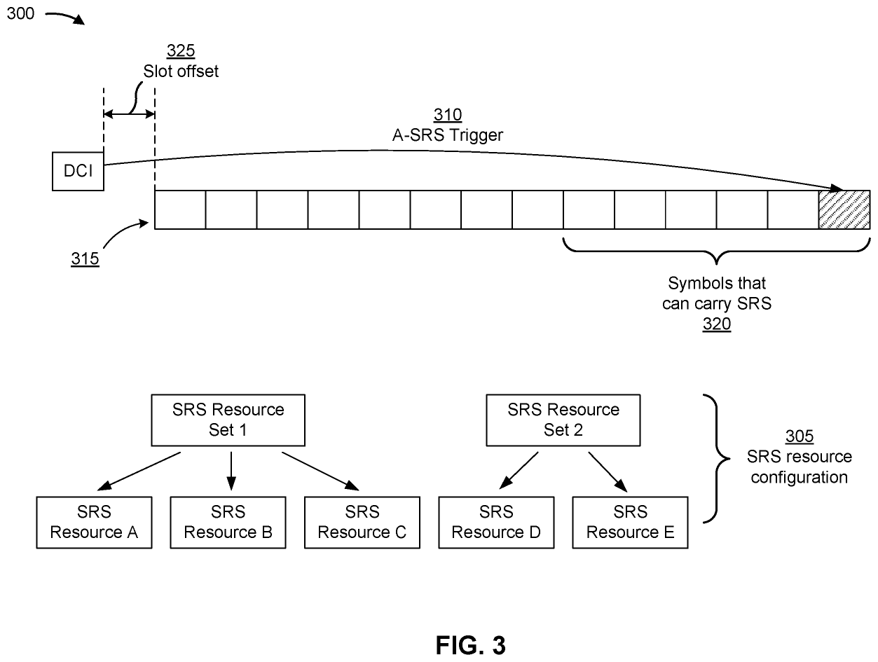

FIG. 3 is a diagram illustrating an example 300 of transmitting an aperiodic sounding reference signal (A-SRS), in accordance with various aspects of the present disclosure.

In order to estimate uplink (UL) channels, a sounding reference signal (SRS) may be transmitted by UEs (e.g., UE 120 shown in FIG. 1). A base station 110 may configure a UE 120 with one or more SRS resource sets to allocate resources for SRS transmissions by the UE 120. For example, a configuration for SRS resource sets may be indicated in a radio resource control (RRC) message (e.g., an RRC configuration message, and RRC reconfiguration message, and/or the like). As shown by reference number 305, an SRS resource set may include one or more resources (e.g., shown as SRS resources A-E), which may include time resources and/or frequency resources (e.g., a slot, a symbol, a resource block, a periodicity for the time resources, and/or the like).

In some aspects, an SRS resource may include one or more antenna ports on which an SRS is to be transmitted (e.g., in a time-frequency resource). Thus, a configuration for an SRS resource set may indicate one or more time-frequency resources in which an SRS is to be transmitted, and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, beam management, and/or the like.

An antenna switching SRS resource set may be used to indicate downlink channel state information (CSI) with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110).

A non-codebook SRS resource set may be used to indicate uplink CSI when the UE 120 selects an uplink precoder (e.g., instead of the base station 110 indicating an uplink precoder to be used by the UE 120). For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110).

A beam management SRS resource set may be used for indicating CSI for millimeter wave communications.

An SRS resource set transmission may be aperiodic, semi-persistent, or periodic. As shown by reference number 310, an A-SRS trigger may be carried in downlink control information (DCI) and may be used to trigger transmission of an A-SRS in a slot 315. NR supports NR SRS resources that can occupy 1, 2, or 4 adjacent symbols in the time domain, with up to 4 ports per SRS resource. As shown by reference number 320, an SRS can only be transmitted in the last 6 symbols of a slot 315 that begins after a slot offset 325. Additionally, under the existing specifications, an SRS can only be transmitted after the PUSCH in that slot.

Current NR specifications support transmitting an A-SRS in only one slot after triggering. Thus, a base station may trigger an A-SRS multiple times to evaluate uplink channels associated with different antennae, different UEs, different channels, different aggregated carriers, and/or the like. Additionally, under current specifications, slot offset is the only A-SRS parameter that can be dynamically configured.

In some aspects, techniques described herein may enable a base station to configure a number (quantity) of candidate slots for transmitting an A-SRS and to trigger an A-SRS for transmission on one or more of the number of candidate slots (referred to herein as a “multi-slot A-SRS”). In some aspects, the number of candidate slots may be greater than one. In some aspects, techniques described herein for triggering a multi-slot A-SRS using a single DCI transmission may facilitate enhanced usefulness of the SRS without increasing overhead. In some aspects, a base station may be able to dynamically configure the duration of the A-SRS transmission, the periodicity of the A-SRS transmission, and the selection of SRS resources from an SRS resource set to be transmitted. Some aspects of this increased functionality may facilitate more efficient evaluation and scheduling of uplink channels, thereby improving uplink reliability, quality of service, and/or the like.

As indicated above, FIG. 3 is provided merely as an example. Other examples may differ from what is described with regard to FIG. 3.

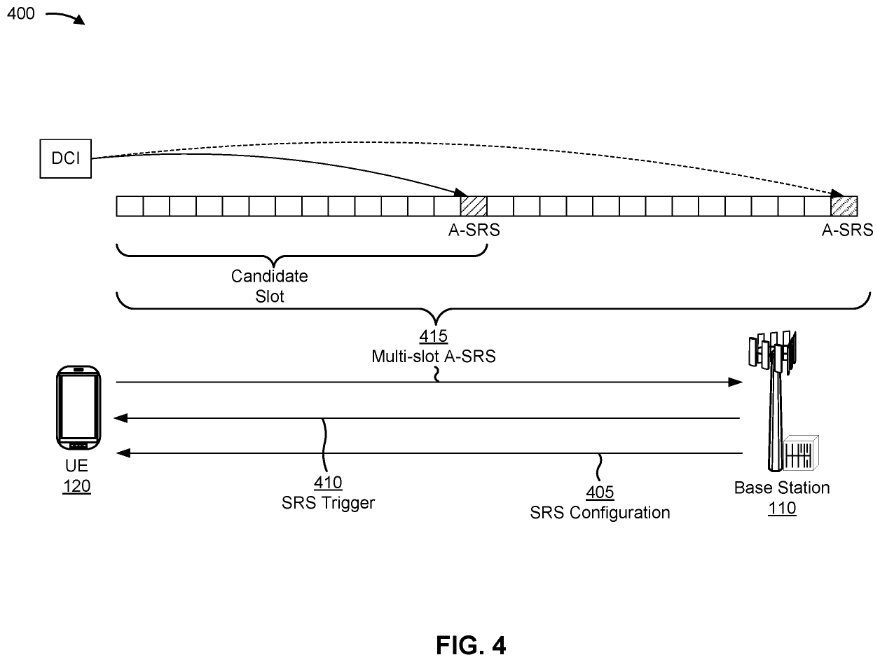

FIG. 4 is a diagram illustrating an example 400 of transmitting a multi-slot A-SRS, in accordance with various aspects of the present disclosure. As shown, a base station 110 and a UE 120 may communicate with one another.

As shown by reference number 405, the base station 110 may transmit, and the UE 120 may receive, an SRS configuration. The SRS configuration may indicate a number of candidate slots for transmitting a multi-slot A-SRS. The SRS configuration may include one or more configuration indications that indicate, for example, a number of the plurality of candidate slots to use for transmitting the multi-slot A-SRS. The term multi-slot A-SRS refers to an A-SRS for which multiple slots are configured, even though, in some aspects, the multi-slot A-SRS may be transmitted in only one of the plurality of candidate slots.

For example, in some aspects, the SRS configuration may include an indication to attempt to transmit an A-SRS in a first slot of a plurality of candidate slots and, if the attempt is unsuccessful, to attempt to transmit the A-SRS in a second slot of the plurality of candidate slots. In some aspects, the first slot and the second slot may be adjacent one another. In some aspects, the second slot may be separated in time from the first slot by one or more slots. In some aspects, the SRS configuration may include an indication to transmit the A-SRS in a first available slot of the plurality of candidate slots, to transmit the A-SRS in multiple slots of the plurality of candidate slots, and/or the like.

As shown by reference number 405, the base station 110 may transmit, and the UE 120 may receive, one or more configuration indications that indicate one or more parameters. In some aspects, the one or more parameters may include an A-SRS duration indication indicating a specified quantity of slots to be used for transmission of the multi-slot A-SRS. In some aspects, the one or more parameters may include a maximum duration indication indicating a maximum quantity of consecutive slots that can be used for transmitting the multi-slot A-SRS. In some aspects, the one or more parameters may include a periodicity indication indicating a slot periodicity to be used for transmitting the multi-slot A-SRS.

In some aspects, the one or more parameters may include a default number of the plurality of candidate slots in which to transmit an A-SRS. For example, in some aspects, the configuration indications may indicate a default number of slots equal to one. In that case, the UE 120 may be configured to attempt to transmit an A-SRS in a first slot of the plurality of candidate slots and, if the attempt is unsuccessful, to attempt to transmit the A-SRS in a second slot of the plurality of candidate slots. If the second attempt is unsuccessful, the UE 120 may be configured to attempt to transmit the A-SRS in a third slot of the plurality of candidate slots, and so on. Upon determining that the UE 120 has successfully transmitted the A-SRS, a default configuration of one transmission may comprise an indication to the UE 120 to refrain from further attempts to transmit the A-SRS.

In some aspects, the one or more configuration indications may be carried in a radio resource control message, a medium access control (MAC) control element, or DCI. In some aspects, one or more of the configuration indications may be preconfigured, thereby reducing configuration overhead.

As shown by reference number 410, the base station 110 may transmit, and the UE 120 may receive, an SRS trigger. The trigger may include an indication of an A-SRS resource set. The A-SRS resource set may include a plurality of A-SRS resources. In some aspects, the SRS trigger may be carried in DCI.

As shown by reference number 415, the UE 120 may transmit, and the base station 110 may receive, a multi-slot A-SRS in one or more of a plurality of candidate slots. The multi-slot A-SRS may be transmitted in response to the SRS trigger and may be transmitted based at least in part on at least a portion of the A-SRS resource set. In some aspects, transmitting the multi-slot A-SRS in one or more of the plurality of candidate slots may be based at least in part on the A-SRS resource set (e.g., including all of the SRS resources in the A-SRS resource set). In some aspects, transmitting the multi-slot A-SRS may include using a subset of the plurality of A-SRS resources.

In some aspects, the UE 120 may transmit the multi-slot A-SRS according to a priority associated with the multi-slot A-SRS. The priority associated with the multi-slot A-SRS may be lower or higher relative to any number of other priorities associated with transmissions. In some aspects, the priority associated with the multi-slot A-SRS may be lower relative to a priority associated with a single-slot A-SRS. Examples of additional priority options are depicted in Table 1, below, and are further described below in connection with FIGS. 6 and 7. In Table 1, the lower portion corresponds to carrier aggregation (CA) communications and the upper portion corresponds to non-CA communications. In some aspects, multi-slot A-SRS may not be enabled for CA-based communications.

TABLE 1

| | PUCCH carrying only CSI report(s) or | | | | | |
|---|---|---|---|---|---|---|
| | only L1-RSRP report(s) | | | | | |
| | | PUCCH carrying semi- | | | | |
| | | persistent/periodic CSI | PUCCH | | | |
| Same carrier, | | report(s) or semi- | carrying | | | |
| same | | persistent/periodic L1- | HARQ-ACK | | | |
| symbol(s) | | RSRP report(s) only | and/or SR | A-SRS | SP-SRS | P-SRS |
| A-SRS | | A-SRS | PUCCH | | A-SRS | A-SRS |
| SP-SRS | PUCCH | PUCCH | PUCCH | A-SRS | | SP-SRS |
| P-SRS | PUCCH | PUCCH | PUCCH | A-SRS | SP-SRS | |
| Multi-slot | | Multi-slot | PUCCH | A-SRS | Multi-slot | Multi-slot |
| A-SRS Opt1 | | A-SRS | | | A-SRS | A-SRS |
| Multi-slot | PUCCH | PUCCH | PUCCH | A-SRS | Multi-slot | Multi-slot |
| A-SRS Opt2 | | | | | A-SRS | A-SRS |

| A carrier not configured for | | | PUCCH/PUSCH | |
|---|---|---|---|---|
| PUSCH/PUCCH | | | transmission | |
| transmission, overlap | PUSCH/PUCCH | | carrying periodic CSI | PUSCH |
| results in uplink | transmission | PUSCH | comprising only | transmission |
| transmission beyond the | carrying HARQ- | transmission | CQI/PMI and/or SRS | carrying |
| UE's indicated uplink | ACK/ positive SR/ | carrying | transmission on another | aperiodic CSI |
| aggregation capability | RI/CRI and/or | aperiodic | serving cell configured for | comprising only |
| included in [13, TS 38.306] | PRACH happen | CSI | PUSCH/PUCCH transmission | CQI/PMI |
| A-SRS | PUSCH/PUCCH | | A-SRS | A-SRS |
| | and/or PRACH | | | |
| SP-SRS | PUSCH/PUCCH | PUSCH | SP-SRS | |
| | and/or PRACH | | | |
| P-SRS | PUSCH/PUCCH | PUSCH | P-SRS | |
| | and/or PRACH | | | |
| Multi-slot A-SRS Opt1 | PUSCH/PUCCH | | Multi-slot A-SRS | Multi-slot A- |
| | and/or PRACH | | | SRS |
| Multi-slot A-SRS Opt2 | PUSCH/PUCCH | PUSCH | Multi-slot A-SRS | |
| | and/or PRACH | | | |

In some aspects, techniques described herein may enable a base station to trigger an A-SRS for transmission on more than one slot (referred to herein as a “multi-slot A-SRS”). In some aspects, techniques described herein for triggering a multi-slot A-SRS using a single DCI transmission may facilitate enhanced usefulness of the SRS without increasing overhead.

As indicated above, FIG. 4 is provided merely as an example. Other examples may differ from what is described with regard to FIG. 4.

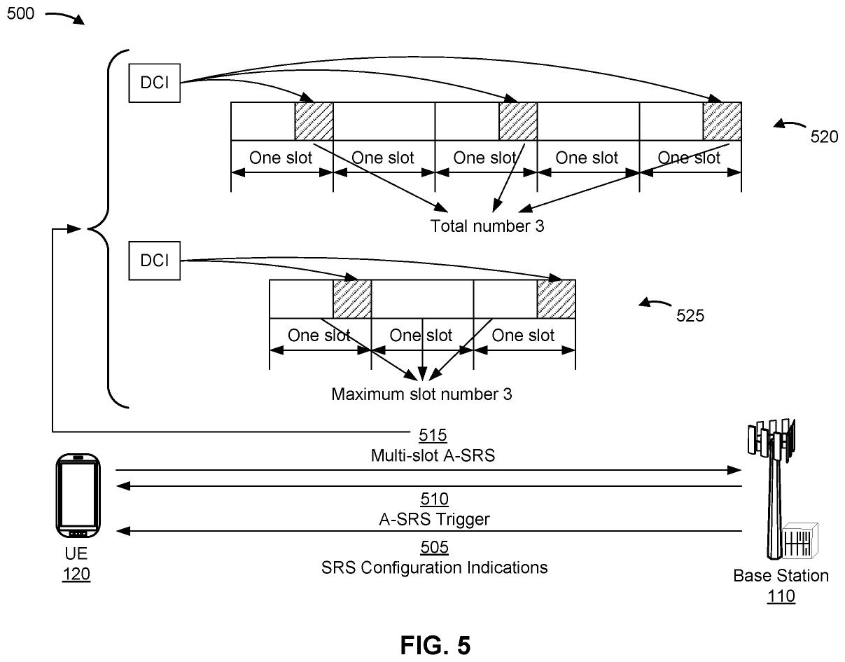

FIG. 5 is a diagram illustrating an example 500 of transmitting a multi-slot aperiodic sounding reference signal, in accordance with various aspects of the present disclosure. As shown, a base station 110 and a UE 120 may communicate with one another.

As shown by reference number 505, the base station 110 may transmit, and the UE 120 may receive, one or more configuration indications that indicate one or more parameters. In some aspects, the one or more parameters may include an A-SRS duration indication indicating a specified quantity of slots to be used for transmission of the multi-slot A-SRS. In some aspects, the one or more parameters may include a maximum duration indication indicating a maximum quantity of consecutive slots that can be used for transmitting the multi-slot A-SRS. In some aspects, the one or more parameters may include a periodicity indication indicating a slot periodicity to be used for transmitting the multi-slot A-SRS.

In some aspects, the one or more configuration indications may be carried in a radio resource control message, a medium access control (MAC) control element, or DCI. In some aspects, one or more of the indications may be preconfigured, thereby reducing configuration overhead.

As shown by reference number 510, the base station 110 may transmit, and the UE 120 may receive, an SRS trigger. The trigger may include an indication of an A-SRS resource set, which may include a plurality of A-SRS resources. As shown by reference number 515, the UE 120 may transmit, and the base station 110 may receive, a multi-slot A-SRS. As shown, the A-SRS may be transmitted in one or more of a plurality of candidate slots using at least a portion of the A-SRS resource set. As is further shown, the plurality of candidate slots within which the A-SRS is transmitted may be based at least in part on one or more of the parameters discussed above. For example, if only duration is configured, the A-SRS may be transmitted within all of the slots indicated by the duration, whereas, if only slot periodicity is configured, the A-SRS may be transmitted within a pre-defined number of candidate slots.

As shown by reference number 520, in some aspects, the duration parameter may be used to configure a total quantity of three candidate slots (each of which is shown as “one slot”) for transmitting the A-SRS, while the periodicity parameter may indicate that the A-SRS is to be transmitted in every other slot. As shown by reference number 525, the maximum duration parameter may indicate a maximum quantity of three slots, while the periodicity may indicate that the A-SRS is to be transmitted in every other slot, thus resulting in a total of two slots carrying the A-SRS.

In some aspects, a base station may be able to dynamically configure the duration of the A-SRS transmission, the periodicity of the A-SRS transmission, and the selection of SRS resources from an SRS resource set to be transmitted. Some aspects of this increased functionality may facilitate more efficient evaluation and scheduling of uplink channels, thereby improving uplink reliability, quality of service, and/or the like.

As indicated above, FIG. 5 is provided merely as an example. Other examples may differ from what is described with regard to FIG. 5.

FIG. 6 is a diagram illustrating an example process 600 performed, for example, by a UE, in accordance with various aspects of the present disclosure. Example process 600 is an example where the UE (e.g., UE 120 and/or the like) performs operations associated with transmitting a multi-slot A-SRS.

As shown in FIG. 6, in some aspects, process 600 may include receiving, from a BS, an SRS configuration indicating a number of candidate slots for transmission of a multi-slot A-SRS (block 610). For example, the UE (e.g., using receive processor 258, controller/processor 280, memory 282, and/or the like) may receive an SRS configuration indicating a plurality of candidate slots for transmission of a multi-slot A-SRS, as described above.

As further shown in FIG. 6, in some aspects, process 600 may include receiving, from the BS, an SRS trigger, the SRS trigger comprising an indication of an A-SRS resource set, the A-SRS resource set comprising a plurality of A-SRS resources corresponding to the number of candidate slots (block 620). For example, the UE (e.g., using receive processor 258, controller/processor 280, memory 282, and/or the like) may receive, from a BS, an SRS trigger, the trigger comprising an indication of an A-SRS resource set, the A-SRS resource set comprising a plurality of A-SRS resources corresponding to the number of candidate slots, as described above.

As further shown in FIG. 6, in some aspects, process 600 may include transmitting, in response to the SRS trigger, the multi-slot A-SRS in one or more of the plurality of candidate slots using at least a portion of the A-SRS resource set (block 630). For example, the UE (e.g., using transmit processor 264, controller/processor 280, memory 282, and/or the like) may transmit, in response to the SRS trigger, the multi-slot A-SRS in one or more of a plurality of candidate slots using at least a portion of the A-SRS resource set, as described above.

Process 600 may include additional aspects, such as any single aspect or any combination of aspects described below and/or in connection with one or more other processes described elsewhere herein.

In a first aspect, the SRS trigger is carried in DCI.

In a second aspect, alone or in combination with the first aspect, transmitting the multi-slot A-SRS in the plurality of slots is based at least in part on the A-SRS resource set.

In a third aspect, alone or in combination with one or more of the first and second aspects, transmitting the multi-slot A-SRS comprises using a subset of the plurality of A-SRS resources to transmit the multi-slot A-SRS in the plurality of slots.

In a fourth aspect, alone or in combination with one or more of the first through third aspects, a set of parameters is preconfigured, and the plurality of slots is based at least in part on one or more parameters of the set of parameters, the set of parameters comprising at least one of: an A-SRS duration indication that indicates a specified quantity of slots to be used for transmission of the multi-slot A-SRS, a maximum duration indication indicating a maximum quantity of consecutive slots that can be used for transmitting the multi-slot A-SRS, a periodicity indication that indicates a slot periodicity to be used for transmitting the multi-slot A-SRS, a default number of slots to be used for transmitting the multi-slot A-SRS, or a combination thereof.

In a fifth aspect, alone or in combination with one or more of the first through fourth aspects, the process 600 includes receiving, from the BS, an A-SRS duration indication indicating a specified quantity of slots to be used for transmission of the multi-slot A-SRS, wherein the plurality of slots comprises the specified quantity of slots.

In a sixth aspect, alone or in combination with one or more of the first through fifth aspects, the duration indication is carried in a radio resource control message, a MAC control element, or DCI.

In a seventh aspect, alone or in combination with one or more of the first through sixth aspects, the process 600 includes receiving, from the BS, a periodicity indication indicating a slot periodicity to be used for transmitting the multi-slot A-SRS, wherein the plurality of slots is based at least in part on the duration indication and the periodicity indication.

In an eighth aspect, alone or in combination with one or more of the first through seventh aspects, process 600 includes receiving, from the BS, a maximum duration indication indicating a maximum quantity of consecutive slots that can be used for transmitting the multi-slot A-SRS.

In a ninth aspect, alone or in combination with one or more of the first through eighth aspects, the maximum duration indication is carried in a radio resource control message, a MAC control element, or downlink control information.

In a tenth aspect, alone or in combination with one or more of the first through ninth aspects, the process 600 includes receiving, from the BS, a periodicity indication indicating a slot periodicity to be used for transmitting the multi-slot A-SRS, wherein the plurality of slots is based at least in part on the maximum duration indication and the periodicity indication.

In an eleventh aspect, alone or in combination with one or more of the first through tenth aspects, process 600 includes receiving, from the base station, a periodicity indication indicating a slot periodicity to be used for transmitting the multi-slot A-SRS.

In a twelfth aspect, alone or in combination with one or more of the first through eleventh aspects, the periodicity indication is carried in a radio resource control message, a MAC control element, or downlink control information.

In a thirteenth aspect, alone or in combination with one or more of the first through twelfth aspects, the process 600 includes transmitting the multi-slot A-SRS according to a priority associated with the multi-slot A-SRS, wherein the priority associated with the multi-slot A-SRS is lower relative to a priority associated with a single-slot A-SRS.

In a fourteenth aspect, alone or in combination with one or more of the first through thirteenth aspects, the process 600 includes transmitting the multi-slot A-SRS according to a priority associated with the multi-slot A-SRS, wherein the priority associated with the multi-slot A-SRS is lower relative to: a priority associated with a physical uplink control channel (PUCCH) transmission carrying a hybrid automatic repeat request acknowledgement, a priority associated with a PUCCH transmission carrying a scheduling request, a priority associated with a PUCCH transmission carrying SP channel state information (CSI), a priority associated with a PUCCH transmission carrying periodic CSI, a priority associated with a PUCCH transmission carrying an SP Layer 1 Reference Signal Received Power (RSRP) report, a priority associated with a PUCCH transmission carrying a periodic Layer 1 RSRP report, or a combination thereof.

In a fifteenth aspect, alone or in combination with one or more of the first through fourteenth aspects, the process 600 includes transmitting the multi-slot A-SRS according to a priority associated with the multi-slot A-SRS, wherein the priority associated with the multi-slot A-SRS is higher relative to: a priority associated with a semi-persistent (SP) SRS, a priority associated with a periodic SRS, a priority associated with a PUCCH transmission carrying SP CSI, a priority associated with a PUCCH transmission carrying periodic CSI, a priority associated with a PUCCH transmission carrying an SP Layer 1 RSRP report, a priority associated with a PUCCH transmission carrying a periodic Layer 1 RSRP report, or a combination thereof.

In a sixteenth aspect, alone or in combination with one or more of the first through fifteenth aspects, the process 600 includes transmitting the multi-slot A-SRS using carrier aggregation and according to a priority associated with the multi-slot A-SRS, wherein the priority associated with the multi-slot A-SRS is lower relative to: a priority associated with a physical uplink shared channel (PUSCH) transmission carrying a hybrid automatic repeat request acknowledgement, a priority associated with a PUSCH transmission carrying a positive scheduling request (SR), a priority associated with a PUSCH transmission carrying a rank indicator (RI), a priority associated with a PUSCH transmission carrying a channel state information reference signal resource indicator (CRI), a priority associated with a PUSCH transmission carrying aperiodic CSI, a priority associated with a PUCCH transmission carrying a positive SR, a priority associated with a PUCCH transmission carrying an RI, a priority associated with a PUCCH transmission carrying a CRI, a priority associated with a physical random access channel transmission, or a combination thereof.

In a seventeenth aspect, alone or in combination with one or more of the first through sixteenth aspects, the process 600 includes transmitting the multi-slot A-SRS using carrier aggregation and according to a priority associated with the multi-slot A-SRS, wherein the priority associated with the multi-slot A-SRS is higher relative to: a priority associated with a PUSCH transmission carrying periodic CSI having only a channel quality indicator (CQI), a priority associated with a PUSCH transmission carrying periodic CSI having only a precoding matrix indicator (PMI), a priority associated with a PUSCH transmission carrying aperiodic CSI, a priority associated with a PUSCH transmission carrying aperiodic CSI having only a CQI, a priority associated with a PUSCH transmission carrying aperiodic CSI having only a PMI, a priority associated with a PUCCH transmission carrying periodic CSI having only a CQI, a priority associated with a PUCCH transmission carrying periodic CSI having only a PMI, an SRS transmission on a serving cell configured for PUSCH and PUCCH transmission that is different from a serving cell on which the multi-slot A-SRS is transmitted, or a combination thereof.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a BS, in accordance with various aspects of the present disclosure. Example process 700 is an example where the BS (e.g., BS 110 and/or the like) performs operations associated with transmitting multi-slot A-SRS.

As shown in FIG. 7, in some aspects, process 700 may include transmitting, to a UE, an SRS configuration indicating a number of candidate slots for transmission of a multi-slot A-SRS (block 710). For example, the BS (e.g., using transmit processor 220, controller/processor 240, memory 242, and/or the like) may transmit, to a UE, an SRS configuration indicating a number of candidate slots for transmission of a multi-slot A-SRS, as described above.

As shown in FIG. 7, in some aspects, process 700 may include transmitting, to the UE, an SRS trigger, the SRS trigger comprising an indication of an A-SRS resource set, the A-SRS resource set comprising a plurality of A-SRS resources corresponding to the number of candidate slots (block 720). For example, the BS (e.g., using transmit processor 220, controller/processor 240, memory 242, and/or the like) may transmit, to a UE, an SRS trigger, the trigger comprising an indication of an A-SRS resource set, the A-SRS resource set comprising a plurality of A-SRS resources corresponding to the number of candidate slots, as described above.

As further shown in FIG. 7, in some aspects, process 700 may include receiving, in response to the SRS trigger, the multi-slot A-SRS that is transmitted in one or more of a plurality of candidate slots using at least a portion of the A-SRS resource set (block 730). For example, the BS (e.g., using receive processor 238, controller/processor 240, memory 242, and/or the like) may receive, in response to the SRS trigger, a multi-slot A-SRS that is transmitted in one or more of the plurality of candidate slots using at least a portion of the A-SRS resource set, as described above.

Process 700 may include additional aspects, such as any single aspect or any combination of aspects described below and/or in connection with one or more other processes described elsewhere herein.

In a first aspect, the SRS trigger is carried in downlink control information.

In a second aspect, alone or in combination with the first aspect, the multi-slot A-SRS transmitted in the one or more of the plurality of slots is based at least in part on the A-SRS resource set.

In a third aspect, alone or in combination with one or more of the first and second aspects, the multi-slot A-SRS is transmitted in the plurality of slots using a subset of the plurality of A-SRS resources.

In a fourth aspect, alone or in combination with one or more of the first through third aspects, a set of parameters is preconfigured, and the plurality of slots is based at least in part on one or more parameters of the set of parameters, the set of parameters comprising at least one of: an A-SRS duration indication that indicates a specified quantity of slots to be used for transmission of the multi-slot A-SRS, a maximum duration indication indicating a maximum quantity of consecutive slots that can be used for transmitting the multi-slot A-SRS, a periodicity indication that indicates a slot periodicity to be used for transmitting the multi-slot A-SRS, a default number of slots to be used for transmitting the multi-slot A-SRS, or a combination thereof.

In a fifth aspect, alone or in combination with one or more of the first through fourth aspects, the process 700 includes transmitting, to the UE, an A-SRS duration indication indicating a specified quantity of slots to be used for transmission of the multi-slot A-SRS, wherein the plurality of slots comprises the specified quantity of slots.

In a sixth aspect, alone or in combination with one or more of the first through fifth aspects, the duration indication is carried in a radio resource control message, a MAC control element, or downlink control information.

In a seventh aspect, alone or in combination with one or more of the first through sixth aspects, the process 700 includes transmitting, to the UE, a periodicity indication indicating a slot periodicity to be used for transmitting the multi-slot A-SRS, wherein the plurality of slots is based at least in part on the duration indication and the periodicity indication.

In an eighth aspect, alone or in combination with one or more of the first through seventh aspects, process 700 includes transmitting, to the UE, a maximum duration indication indicating a maximum quantity of consecutive slots that can be used for transmitting the multi-slot A-SRS.

In a ninth aspect, alone or in combination with one or more of the first through eighth aspects, the maximum duration indication is carried in a radio resource control message, a MAC control element, or downlink control information.

In a tenth aspect, alone or in combination with one or more of the first through ninth aspects, the process 700 includes transmitting, to the UE, a periodicity indication indicating a slot periodicity to be used for transmitting the multi-slot A-SRS, wherein the plurality of slots is based at least in part on the maximum duration indication and the periodicity indication.

In an eleventh aspect, alone or in combination with one or more of the first through tenth aspects, process 700 includes transmitting, to the UE, a periodicity indication indicating a slot periodicity to be used for transmitting the multi-slot A-SRS.

In a twelfth aspect, alone or in combination with one or more of the first through eleventh aspects, the periodicity indication is carried in a radio resource control message, a MAC control element, or downlink control information.

In a thirteenth aspect, alone or in combination with one or more of the first through twelfth aspects, the multi-slot A-SRS is transmitted according to a priority associated with the multi-slot A-SRS, and the priority associated with the multi-slot A-SRS is lower relative to a priority associated with a single-slot A-SRS.

In a fourteenth aspect, alone or in combination with one or more of the first through thirteenth aspects, the multi-slot A-SRS is transmitted according to a priority associated with the multi-slot A-SRS, the priority associated with the multi-slot A-SRS is lower relative to: a priority associated with a PUCCH transmission carrying a hybrid automatic repeat request acknowledgement, a priority associated with a PUCCH transmission carrying a scheduling request, a priority associated with a PUCCH transmission carrying SP CSI, a priority associated with a PUCCH transmission carrying periodic CSI, a priority associated with a PUCCH transmission carrying an SP Layer 1 RSRP report, a priority associated with a PUCCH transmission carrying a periodic Layer 1 RSRP report, or a combination thereof.

In a fifteenth aspect, alone or in combination with one or more of the first through fourteenth aspects, the multi-slot A-SRS is transmitted according to a priority associated with the multi-slot A-SRS, the priority associated with the multi-slot A-SRS is higher relative to: a priority associated with an SP SRS, a priority associated with a periodic SRS, a priority associated with a PUCCH transmission carrying SP CSI, a priority associated with a PUCCH transmission carrying periodic CSI, a priority associated with a PUCCH transmission carrying an SP Layer 1 RSRP report, a priority associated with a PUCCH transmission carrying a periodic Layer 1 RSRP report, or a combination thereof.

In a sixteenth aspect, alone or in combination with one or more of the first through fifteenth aspects, the multi-slot A-SRS is transmitted using carrier aggregation and according to a priority associated with the multi-slot A-SRS, the priority associated with the multi-slot A-SRS is lower relative to: a priority associated with a PUSCH transmission carrying a hybrid automatic repeat request acknowledgement, a priority associated with a PUSCH transmission carrying a positive SR, a priority associated with a PUSCH transmission carrying an RI, a priority associated with a PUSCH transmission carrying a CRI, a priority associated with a PUSCH transmission carrying aperiodic CSI, a priority associated with a PUCCH transmission carrying a positive SR, a priority associated with a PUCCH transmission carrying an RI, a priority associated with a PUCCH transmission carrying a CRI, a priority associated with a physical random access channel transmission, or a combination thereof.

In a seventeenth aspect, alone or in combination with one or more of the first through sixteenth aspects, the multi-slot A-SRS is transmitted using carrier aggregation and according to a priority associated with the multi-slot A-SRS, the priority associated with the multi-slot A-SRS is higher relative to: a priority associated with a PUSCH transmission carrying periodic CSI having only a CQI, a priority associated with a PUSCH transmission carrying periodic CSI having only a PMI, a priority associated with a PUSCH transmission carrying aperiodic CSI, a priority associated with a PUSCH transmission carrying aperiodic CSI having only a CQI, a priority associated with a PUSCH transmission carrying aperiodic CSI having only a PMI, a priority associated with a PUCCH transmission carrying periodic CSI having only a CQI, a priority associated with a PUCCH transmission carrying periodic CSI having only a PMI, an SRS transmission on a serving cell configured for PUSCH and PUCCH transmission that is different from a serving cell on which the multi-slot A-SRS is transmitted, or a combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1-42. (canceled)

43. A user equipment (UE) for wireless communication, comprising:
a memory; and
one or more processors, coupled to the memory, configured to:
receive, from a base station (BS), a sounding reference signal (SRS) configuration indicating a number of candidate slots for transmission of a multi-slot aperiodic SRS (A-SRS);
receive, from the BS, an SRS trigger, the SRS trigger comprising an indication of an A-SRS resource set, the A-SRS resource set comprising a plurality of A-SRS resources corresponding to the number of candidate slots; and
transmit, in response to the SRS trigger, the multi-slot A-SRS in one or more of a plurality of candidate slots using at least a portion of the A-SRS resource set.

44. The UE of claim 43, wherein the SRS trigger is carried in downlink control information.

45. The UE of claim 43, wherein transmitting the multi-slot A-SRS in the plurality of slots is based at least in part on the A-SRS resource set.

46. The UE of claim 43, wherein the one or more processors, to transmit the multi-slot A-SRS, are configured to use a subset of the plurality of A-SRS resources to transmit the multi-slot A-SRS in the plurality of slots.

47. The UE of claim 43, wherein a set of parameters is preconfigured, and wherein the plurality of slots is based at least in part on one or more parameters of the set of parameters, the set of parameters comprising at least one of:
an A-SRS duration indication that indicates a specified quantity of slots to be used for transmission of the multi-slot A-SRS,
a maximum duration indication indicating a maximum quantity of consecutive slots that can be used for transmitting the multi-slot A-SRS,
a periodicity indication that indicates a slot periodicity to be used for transmitting the multi-slot A-SRS,
a default number of slots to be used for transmitting the multi-slot A-SRS, or
a combination thereof.

48. The UE of claim 43, wherein the one or more processors are further configured to receive, from the BS, an A-SRS duration indication indicating a specified quantity of slots to be used for transmission of the multi-slot A-SRS, wherein the plurality of slots comprises the specified quantity of slots.

49. The UE of claim 48, wherein the A-SRS duration indication is carried in a radio resource control message, a medium access control (MAC) control element, or downlink control information.

50. The UE of claim 48, wherein the one or more processors are further configured to receive, from the BS, a periodicity indication indicating a slot periodicity to be used for transmitting the multi-slot A-SRS, wherein the plurality of slots is based at least in part on the A-SRS duration indication and the periodicity indication.

51. The UE of claim 43, wherein the one or more processors are further configured to receive, from the BS, a maximum duration indication indicating a maximum quantity of consecutive slots that can be used for transmitting the multi-slot A-SRS.

52. The UE of claim 51, wherein the maximum duration indication is carried in a radio resource control message, a medium access control (MAC) control element, or downlink control information.

53. The UE of claim 51, wherein the one or more processors are further configured to receive, from the B S, a periodicity indication indicating a slot periodicity to be used for transmitting the multi-slot A-SRS, wherein the plurality of slots is based at least in part on the maximum duration indication and the periodicity indication.

54. The UE of claim 43, wherein the one or more processors are further configured to receive, from the base station, a periodicity indication indicating a slot periodicity to be used for transmitting the multi-slot A-SRS.

55. The UE of claim 54, wherein the periodicity indication is carried in a radio resource control message, a medium access control (MAC) control element, or downlink control information.

56. The UE of claim 43, wherein the one or more processors are further configured to transmit the multi-slot A-SRS according to a priority associated with the multi-slot A-SRS, wherein the priority associated with the multi-slot A-SRS is lower relative to a priority associated with a single-slot A-SRS.

57. The UE of claim 43, wherein the one or more processors are further configured to transmit the multi-slot A-SRS according to a priority associated with the multi-slot A-SRS, wherein the priority associated with the multi-slot A-SRS is lower relative to:
a priority associated with a physical uplink control channel (PUCCH) transmission carrying a hybrid automatic repeat request acknowledgement,
a priority associated with a PUCCH transmission carrying a scheduling request,
a priority associated with a PUCCH transmission carrying SP channel state information (CSI),
a priority associated with a PUCCH transmission carrying periodic CSI,
a priority associated with a PUCCH transmission carrying an SP Layer 1 Reference Signal Received Power (RSRP) report,
a priority associated with a PUCCH transmission carrying a periodic Layer 1 RSRP report, or
a combination thereof.

58. The UE of claim 43, wherein the one or more processors are further configured to transmit the multi-slot A-SRS according to a priority associated with the multi-slot A-SRS, wherein the priority associated with the multi-slot A-SRS is higher relative to:
a priority associated with a semi-persistent (SP) SRS,
a priority associated with a periodic SRS,
a priority associated with a physical uplink control channel (PUCCH) transmission carrying SP channel state information (CSI),
a priority associated with a PUCCH transmission carrying periodic CSI,
a priority associated with a PUCCH transmission carrying an SP Layer 1 Reference Signal Received Power (RSRP) report,
a priority associated with a PUCCH transmission carrying a periodic Layer 1 RSRP report, or
a combination thereof.

59. The UE of claim 43, wherein the one or more processors are further configured to transmit the multi-slot A-SRS using carrier aggregation and according to a priority associated with the multi-slot A-SRS, wherein the priority associated with the multi-slot A-SRS is lower relative to:
a priority associated with a physical uplink shared channel (PUSCH) transmission carrying a hybrid automatic repeat request acknowledgement,
a priority associated with a PUSCH transmission carrying a positive scheduling request (SR),
a priority associated with a PUSCH transmission carrying a rank indicator (RI),
a priority associated with a PUSCH transmission carrying a channel state information reference signal resource indicator (CRI),
a priority associated with a PUSCH transmission carrying aperiodic CSI,
a priority associated with a physical uplink control channel (PUCCH) transmission carrying a positive SR,
a priority associated with a PUCCH transmission carrying an RI,
a priority associated with a PUCCH transmission carrying a CRI,
a priority associated with a physical random access channel transmission, or
a combination thereof.

60. The UE of claim 43, wherein the one or more processors are further configured to transmit the multi-slot A-SRS using carrier aggregation and according to a priority associated with the multi-slot A-SRS, wherein the priority associated with the multi-slot A-SRS is higher relative to:
a priority associated with a physical uplink shared channel (PUSCH) transmission carrying periodic channel state information (CSI) having only a channel quality indicator (CQI),
a priority associated with a PUSCH transmission carrying periodic CSI having only a precoding matrix indicator (PMI),
a priority associated with a PUSCH transmission carrying aperiodic CSI,
a priority associated with a PUSCH transmission carrying aperiodic CSI having only a CQI,
a priority associated with a PUSCH transmission carrying aperiodic CSI having only a PMI,
a priority associated with a physical uplink control channel (PUCCH) transmission carrying periodic CSI having only a CQI,
a priority associated with a PUCCH transmission carrying periodic CSI having only a PMI,
an SRS transmission on a serving cell configured for PUSCH and PUCCH transmission that is different from a serving cell on which the multi-slot A-SRS is transmitted, or
a combination thereof.

61. A base station for wireless communication, comprising:
a memory; and
one or more processors, coupled to the memory, configured to:
transmit, to a user equipment (UE), a sounding reference signal (SRS) configuration indicating a number of candidate slots for transmission of a multi-slot aperiodic SRS (A-SRS);
transmit, to the UE, a sounding reference signal (SRS) trigger, the SRS trigger comprising an indication of an A-SRS resource set, the A-SRS resource set comprising a plurality of A-SRS resources corresponding to the number of candidate slots; and
receive, in response to the SRS trigger, the multi-slot A-SRS that is transmitted in one or more of a plurality of candidate slots using at least a portion of the A-SRS resource set.

62. The base station of claim 61, wherein the SRS trigger is carried in downlink control information.

63. The base station of claim 61, wherein the multi-slot A-SRS transmitted in the plurality of slots is based at least in part on the A-SRS resource set.

64. The base station of claim 61, wherein a set of parameters is preconfigured, and wherein the plurality of slots is based at least in part on one or more parameters of the set of parameters, the set of parameters comprising at least one of:
an A-SRS duration indication that indicates a specified quantity of slots to be used for transmission of the multi-slot A-SRS,
a maximum duration indication indicating a maximum quantity of consecutive slots that can be used for transmitting the multi-slot A-SRS,
a periodicity indication that indicates a slot periodicity to be used for transmitting the multi-slot A-SRS,
a default number of slots to be used for transmitting the multi-slot A-SRS, or
a combination thereof.

65. The base station of claim 61, wherein the one or more processors are further configured to transmit, to the UE, an A-SRS duration indication indicating a specified quantity of slots to be used for transmission of the multi-slot A-SRS, wherein the plurality of slots comprises the specified quantity of slots.

66. The base station of claim 61, wherein the one or more processors are further configured to transmit, to the UE, a maximum duration indication indicating a maximum quantity of consecutive slots that can be used for transmitting the multi-slot A-SRS.

67. The base station of claim 61, wherein the one or more processors are further configured to transmit, to the UE, a periodicity indication indicating a slot periodicity to be used for transmitting the multi-slot A-SRS.

68. The base station of claim 61, wherein the multi-slot A-SRS is transmitted according to a priority associated with the multi-slot A-SRS, wherein the priority associated with the multi-slot A-SRS is lower relative to a priority associated with a single-slot A-SRS.

69. A method of wireless communication performed by a user equipment (UE), comprising:
receiving, from a base station (BS), a sounding reference signal (SRS) configuration indicating a number of candidate slots for transmission of a multi-slot aperiodic SRS (A-SRS);
receiving, from the BS, an SRS trigger, the SRS trigger comprising an indication of an A-SRS resource set, the A-SRS resource set comprising a plurality of A-SRS resources corresponding to the number of candidate slots; and
transmitting, in response to the SRS trigger, the multi-slot A-SRS in one or more of a plurality of candidate slots using at least a portion of the A-SRS resource set.

70. The method of claim 69, wherein a set of parameters is preconfigured, and wherein the plurality of slots is based at least in part on one or more parameters of the set of parameters, the set of parameters comprising at least one of:
an A-SRS duration indication that indicates a specified quantity of slots to be used for transmission of the multi-slot A-SRS,
a maximum duration indication indicating a maximum quantity of consecutive slots that can be used for transmitting the multi-slot A-SRS,
a periodicity indication that indicates a slot periodicity to be used for transmitting the multi-slot A-SRS,
a default number of slots to be used for transmitting the multi-slot A-SRS, or
a combination thereof.

71. A method of wireless communication performed by a base station, comprising:
transmitting, to a user equipment (UE), a sounding reference signal (SRS) configuration indicating a number of candidate slots for transmission of a multi-slot aperiodic SRS (A-SRS);
transmitting, to the UE, a sounding reference signal (SRS) trigger, the SRS trigger comprising an indication of an A-SRS resource set, the A-SRS resource set comprising a plurality of A-SRS resources corresponding to the number of candidate slots; and
receiving, in response to the SRS trigger, the multi-slot A-SRS that is transmitted in one or more of a plurality of candidate slots using at least a portion of the A-SRS resource set.

72. The method of claim 71, wherein a set of parameters is preconfigured, and wherein the plurality of slots is based at least in part on one or more parameters of the set of parameters, the set of parameters comprising at least one of:
an A-SRS duration indication that indicates a specified quantity of slots to be used for transmission of the multi-slot A-SRS,
a maximum duration indication indicating a maximum quantity of consecutive slots that can be used for transmitting the multi-slot A-SRS,
a periodicity indication that indicates a slot periodicity to be used for transmitting the multi-slot A-SRS,
a default number of slots to be used for transmitting the multi-slot A-SRS, or
a combination thereof.
